(19) United States
(12) Patent Application Publication
(10) Pub. No.: US 2008/0036381 A1
(43) Pub. Date: Feb. 14, 2008

(54) Plasma display panel and method of fabricating the same

(76) Inventor: Tae-Kyoung Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/889,253

(22) Filed: Aug. 10, 2007

(30) Foreign Application Priority Data
Aug. 11, 2006 (KR) 10-2006-0076208

(51) Int. Cl. H01J 9/02; H01J 9/233

(52) U.S. Cl. 313/586; 445/24

(57) ABSTRACT

A plasma display panel includes first and second substrates positioned in parallel to each other to define display and non-display areas, a plurality of barrier ribs between the first and second substrates, a plurality of discharge electrodes between the first and second substrates, the discharge electrodes having electrode terminals in the non-display area, a dielectric layer on the discharge electrodes in the display area, and a plurality of short-circuit prevention units between the electrode terminals.

### BACKGROUND OF THE INVENTION

1. Field of the Invention

Embodiments of the present invention relate to a plasma display panel and a method of fabricating the same. More particularly, embodiments of the present invention relate to a plasma display panel having a structure capable of minimizing a short-circuit between electrode terminals thereof.

2. Description of the Related Art

In general, plasma display panels (PDPs) refer to flat panel display apparatuses capable of displaying images using gas discharge phenomenon, i.e., applying voltage to a discharge gas to generate discharge and to excite photoluminescent layers to emit visible light. Conventional PDPs may be classified into alternating current (AC) PDPs and direct current (DC) PDPs with respect to a type of driving voltage employed therein. In addition, the PDPs may be divided into surface discharge PDPs and facing discharge PDPs with respect to electrode structures therein.

A conventional PDP, e.g., an AC three-electrode surface discharge type PDP, may include front and rear substrates with discharge electrodes therebetween, barrier ribs between the front and rear substrates to define discharge spaces, and photoluminescent layers in the discharge spaces. Conventional discharge electrodes may include electrode terminals formed of silver to facilitate connection to a signal transmission unit.

However, silver may be ionized by moisture in the atmosphere, and may trigger electron and/or material migration from one electrode to another. Such an electron migration may cause a short-circuit between adjacent electrode terminals, thereby generating display defects, e.g., a vertical line defect in a displayed image.

### SUMMARY OF THE INVENTION

Embodiments of the present invention are therefore directed to a plasma display panel (PDP) and a method of fabricating the same, which substantially overcome one or more of the disadvantages of the related art

It is therefore a feature of an embodiment of the present invention to provide a PDP having a structure capable of minimizing electron migration between adjacent electrode terminals thereof.

It is another feature of an embodiment of the present invention to provide a method of fabricating a PDP capable of minimizing short circuits between adjacent electrode terminals thereof.

At least one of the above and other features and advantages of the present invention may be realized by providing a PDP, including first and second substrates positioned in parallel to each other to define display and non-display areas, a plurality of barrier ribs between the first and second substrates, a plurality of discharge electrodes between the first and second substrates, the discharge electrodes having electrode terminals in the non-display area, a dielectric layer on the discharge electrodes in the display area, and a plurality of short-circuit prevention units between the electrode terminals.

Each short-circuit prevention unit may be between two adjacent electrode terminals. A length of the short-circuit prevention units may substantially equal a length of the electrode terminals. The short-circuit prevention units may be connected to the dielectric layer. The short-circuit prevention units may be integral with the dielectric layer. The short-circuit prevention units may include a dielectric material.

The short-circuit prevention units may have a structure of group units. The short-circuit prevention units may have non-uniform widths. The short-circuit prevention units in a center of each group unit may be wider than short-circuit prevention units at an edge of each group unit. A width of the short-circuit prevention units may gradually decrease with respect to increase of a distance thereof from the center of each group unit. The dielectric layer may be non-continuous, and may be connected to the short-circuit prevention units.

The PDP may further include at least one signal transmission unit electrically connected to the electrode terminals. The signal transmission unit may include a driving integrated circuit (IC) and at least one lead connected to the driving IC, the lead being connected to a respective electrode terminal. The PDP may further include a sealing member around a connection region of the electrode terminal and its respective lead. Additionally, the PDP may include a connection member between each electrode terminal and a respective lead. The connection member may be an anisotropic conductive film or a non-conductive film.

At least one of the above and other features and advantages of the present invention may be further realized by providing a method of fabricating a PDP, including patterning discharge electrodes on a substrate, depositing a dry film resist on the substrate to cover terminals of the discharge electrodes, exposing and developing the dry film resist to form negative patterns, printing a dielectric material on the substrate, patterning the dielectric material to form a plurality of short-circuit prevention units in the negative patterns and a dielectric layer on the substrate, such that the short-circuit prevention units and the dielectric layer are in communication with each other, and removing the dry film resist to expose the electrode terminals.

Patterning the dielectric material may include forming the dielectric layer and the plurality of short-circuit prevention units simultaneously. Patterning the dielectric material to form the dielectric layer may include forming a non-continuous dielectric layer substantially overlapping with the discharge electrodes. Patterning the dielectric material to form the short-circuit prevention units may include forming protrusion between adjacent discharge electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded partial perspective view of a plasma display panel (PDP) according to an embodiment of the present invention;

FIG. 2 illustrates a plan view of signal transmission units connected to a PDP according to an embodiment of the present invention;

FIG. 3 illustrates a partial plan view of short-circuit prevention units of a PDP according to an embodiment of the present invention;

FIG. 4 illustrates an enlarged cross-sectional view of a connection between an electrode terminal of a PDP and a signal transmission unit according to an embodiment of the present invention;

FIG. 5 illustrates a cross-sectional view of a connection member according to an embodiment of the present invention;

FIG. 6 illustrates a cross-sectional view of a connection member according to another embodiment of the present invention;

FIG. 7 illustrates a partial plan view of a PDP according to another embodiment of the present invention;

FIG. 8 illustrates a partial plan view of a PDP according to another embodiment of the present invention; and

FIGS. 9A-9F illustrate cross-sectional views of sequential steps during fabrication of short-circuit prevention units of a PDP according to an embodiment of the present invention.

### DETAILED DESCRIPTION OF THE INVENTION

Korean Patent Application No. 10-2006-0076208, filed on Aug. 11, 2006, in the Korean Intellectual Property Office, and entitled: “PDP and Method of Fabricating the Same,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers or elements may also be present. Further, it will be understood that the term “on” can indicate solely a vertical arrangement of one element or layer with respect to another element or layer, and may not indicate a specific vertical orientation. In addition, it will also be understood that when a layer is referred to as being “between” two layers, it can be the only layer between the two layers, or one or more intervening layers may also be present. Like reference numerals refer to like elements throughout.

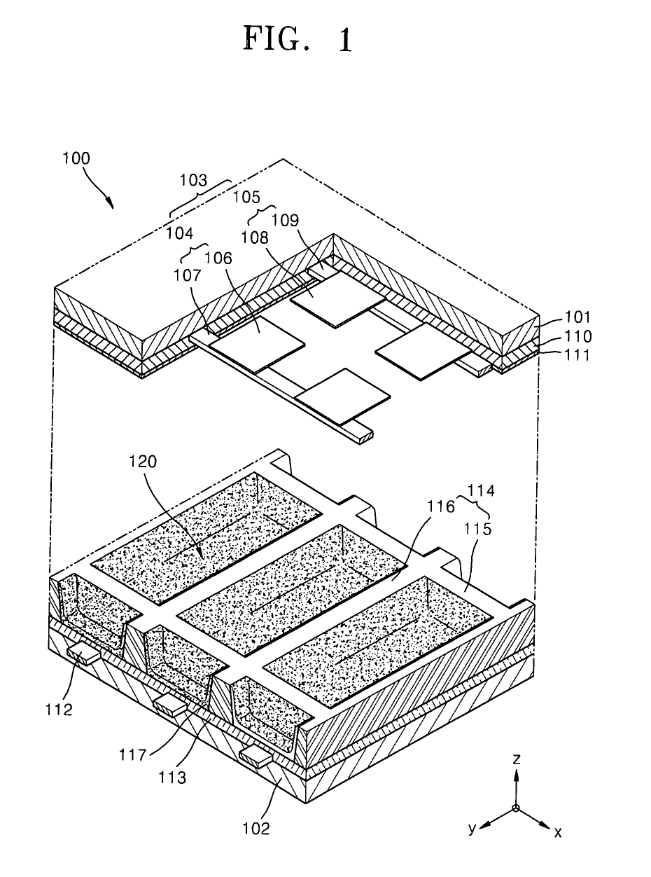

An exemplary embodiment of a plasma display panel (PDP) according to the present invention will now be described more fully with reference to FIGS. 1-6. As illustrated in FIGS. 1-3, a PDP 100 may include front and rear substrates 101 and 102 with discharge electrodes therebetween, barrier ribs 114 between the front and rear substrates 101 and 102 to define discharge cells 120, photoluminescent layers 117 in the discharge cells 120, and short-circuit preventing units 604 between electrode terminals 204. At least one signal transmission unit 205 may be connected to the electrode terminals 204 of the discharge electrodes to drive the PDP 100.

The front and rear substrates 101 and 102 may be disposed in parallel, and may face each other. Each one of the front and rear substrates 101 and 102 may be any one of a transparent substrate, e.g., formed of soda lime glass, a semi-transmissible substrate, a reflective substrate, or a colored substrate. A frit glass layer 203 may be applied to peripheral areas of inner surfaces of the front and rear substrates 101 and 102 to connect therebetween in order to form a sealed space between the front and rear substrates 101 and 102. The sealed space, i.e., a display area 201, may include functional elements, e.g., the discharge electrodes and the discharge cells 120, and may provide display functions. In this respect, it should be noted that “inner surfaces” may refer to surfaces facing the sealed space.

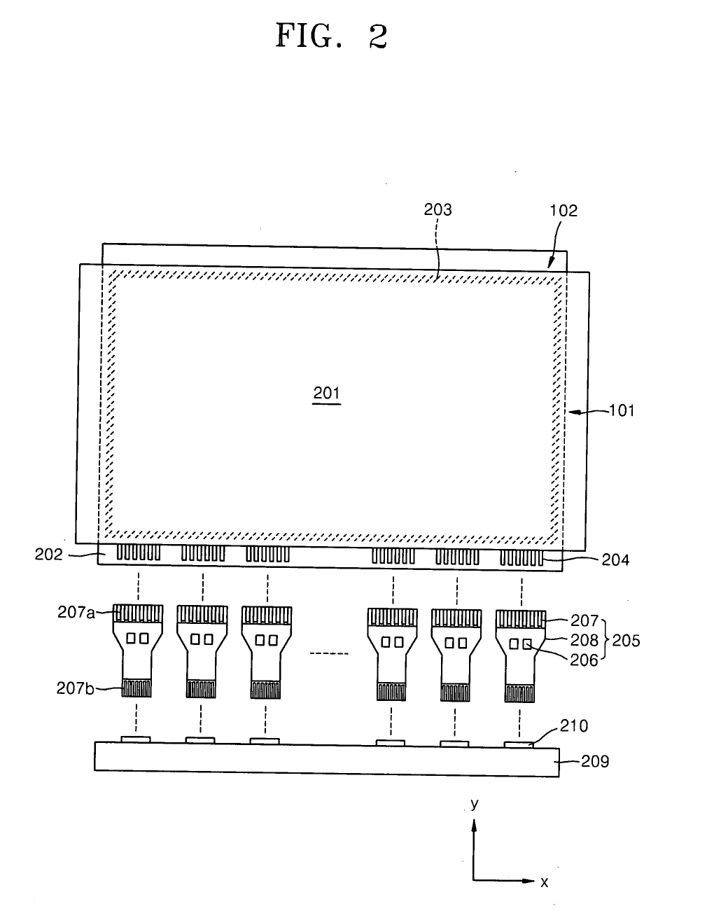

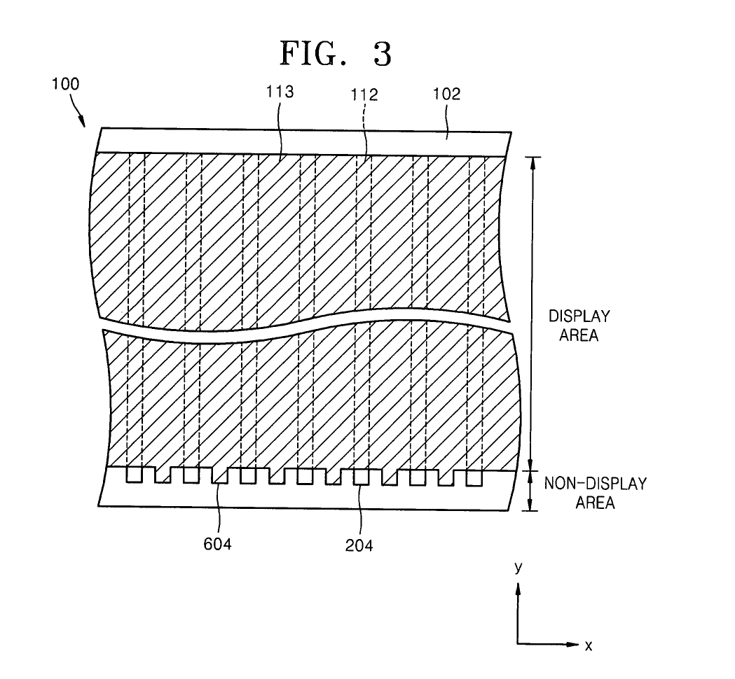

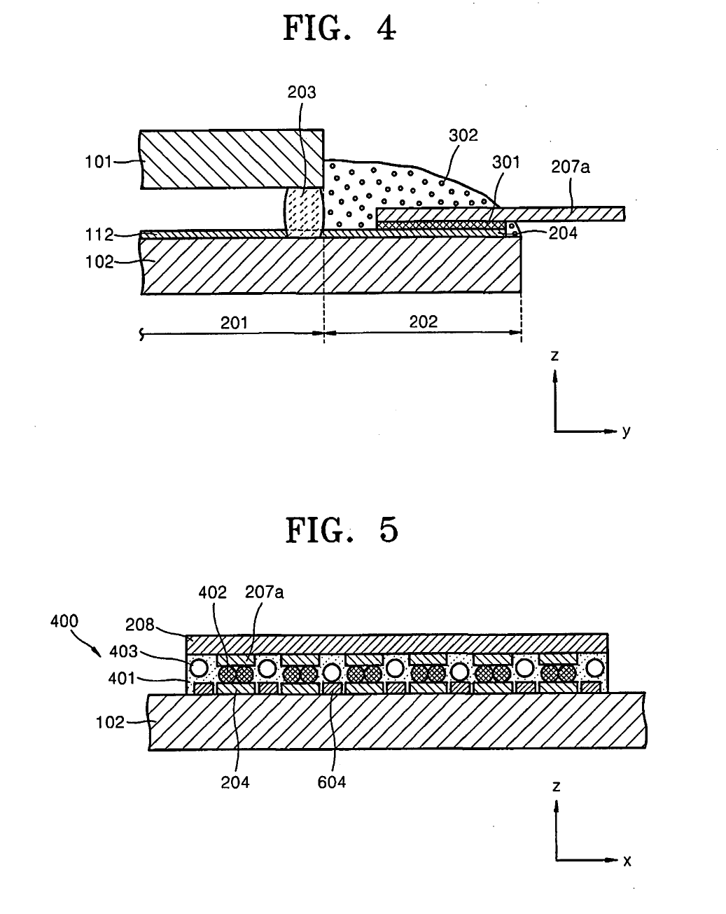

As illustrated in FIG. 2, the front substrate 101 may be shorter than the rear substrate 102, e.g., along the y-axis. Accordingly, the display area 201 may include only an area formed by an overlap of the front and rear substrates 101 and 102. Portions of the rear substrate 102 extending, e.g., along the y-axis, beyond the front substrate 101 may be referred to as a non-display area 202, and may include the electrode terminals 204 of the discharge electrodes. The non-display area 202 may be a peripheral area in communication with at least one edge of the display area 201 to expose the electrode terminals 204, thereby facilitating electrical connection thereof to the signal transmission unit 205, as will be discussed in more detail below with respect to FIGS. 4-6. The PDP 100 may include a plurality of non-display areas 202, i.e., the rear substrate 102 may extend beyond more than a single edge of the front substrate 101.

The discharge electrodes of the PDP 100 may be formed in the display area 201, and may include sustain electrodes 103 and address electrodes 112. More specifically, the sustain electrodes 103 and/or the address electrodes 112 may extend along the display area 201, and may have electrode terminals 204 in the non-display area 202. In this respect, it should be noted that unless otherwise indicated, “discharge electrodes” may refer to the sustain electrodes 103 and/or the address electrodes 112, and therefore, the electrode terminals 204 may refer to terminals of the sustain electrodes 103 and/or the address electrodes 112.

The sustain electrodes 103 of the PDP 100 may be disposed on an inner surface of the front substrate 101 to extend along the x-axis, and may be spaced apart from each other, as illustrated in FIG. 1. The sustain electrodes 103 may include pairs of an X electrode 104 and a Y electrode 105, so that a single pair of the X and Y electrodes 104 and 105 may correspond to a single array of discharge cells 120 extending along the x-axis.

Each X electrode 104 of the sustain electrodes 103 may include a first bus electrode line 107 and a plurality of first transparent electrodes 106. The first bus electrode line 107 may extend along an array of discharge cells 120 along the x-axis. The first transparent electrodes 106 may be independently disposed in each of the discharge cells 120, and may be electrically connected to each other via the first bus electrode line 107, as illustrated in FIG. 1. Each Y electrode 105 of the sustain electrodes 103 may include a plurality of second transparent electrodes 108 connected to a second bus electrode line 109, as further illustrated in FIG. 1. The structure and composition of the second transparent electrodes 108 and second bus electrode line 109 of the Y electrodes 105 may be substantially similar to the structure and composition of the first transparent electrodes 106 and first bus electrode line 107 of the X electrodes 104, respectively.

The first and second transparent electrodes 106 and 108 of the X and Y electrodes 104 and 105, respectively, may have rectangular cross sections, and may be spaced apart from each other in each discharge cell 120 to form a discharge gap therebetween. The first and second transparent electrodes 106 and 108 may be formed of a transparent conductive film, e.g., indium tin oxide (ITO). The first and second bus electrode lines 107 and 109 of the X and Y electrodes 104 and 105 may be spaced apart from each other along opposing edges of arrays of discharge cells 120 along the x-axis, e.g., a plurality of first and second bus electrode lines 107 and 109 may form a stripe-pattern, and may be formed of metal, e.g., a silver (Ag) paste or a chromium-cobalt alloy (Cr—Co—Cr) with high conductivity.

The X and Y electrodes 104 and 105 may be covered by a front dielectric layer 110 formed of a transparent dielectric material, e.g., a mixture of PbO'B₂O₃—SiO₂ having a high electricity. The front dielectric layer 110 may be disposed in the entire display area 202. A protective layer 111 may be formed of magnesium oxide (MgO) on an inner surface of the front dielectric layer 110 in order to increase emission of secondary electrons.

The address electrodes 112 of the PDP 100 may be disposed on an inner surface of the rear substrate 102 to extend along the y-axis, i.e., in a direction crossing the sustain electrodes 103. Each address electrode 112 may extend along an array of discharge cells 120 arranged along the y-axis, so that a plurality of address electrodes 112 may form a stripe-pattern. The address electrodes 112 may be spaced apart from each other at predetermined intervals. A rear dielectric layer 113 may be disposed on the address electrodes 112, so that the rear dielectric layer 113 may be disposed between the address electrodes 112 and the front substrate 101. The rear dielectric layer 113 may be formed of a substantially similar material as the front dielectric layer 110, and it may be disposed in the entire display area 202.

The electrode terminals 204 of the PDP 100 may be formed by drawing the sustain electrodes 103 and/or the address electrodes 112 to the non-display area 202 and patterning edges thereof. For example, if the electrode terminals 204 are terminals of the address electrodes 112, the electrode terminals 204 may extend on an upper surface of the rear substrate 102 along the y-axis, and may be arranged in a stripe-pattern along the x-axis in the non-display area 202, as illustrated in FIG. 2. The electrode terminals 204 may have a structure of group units. In other words, the electrode terminals 204 may be arranged into a plurality of group units spaced apart from each other, each group unit having a plurality of electrode terminals 204, as illustrated in FIG. 2. A single group unit of electrode terminals 204 may correspond to a single transmission unit 205. Accordingly, a large size of the PDP 100 may require a plurality of signal transmission units 205 connected to a plurality of electrode terminals 204 arranged into a plurality of group units. The electrode terminals 204 may not be covered by the rear dielectric layer 113 and/or by the front dielectric layer 110 to facilitate electrical connection to the signal transmission unit 205.

The barrier ribs 114 of the PDP 100 may be disposed between the front and rear substrates 101 and 102 to define the discharge cells 120 and to prevent cross talk therebetween. The barrier ribs 114 may include first barrier ribs 115 along the x-axis and second barrier ribs 116 along the y-axis, as further illustrated in FIG. 1. The first barrier ribs 115 may extend between adjacent second barrier ribs 116 to partition the discharge space into a plurality of discharge cells 120 arranged in any suitable pattern, e.g., a matrix. Accordingly, the discharge cells 120 may have any suitable geometrical shape, e.g., a polygon, a circle, or an oval, in plan view. A discharge gas, e.g., neon (Ne), xenon (Xe), helium (He), or a combination thereof, may be filled in the discharge cells 120.

The photoluminescent layers 117 of the PDP 100 may be disposed on inner surfaces of the discharge cells 120, so that voltage applied to the discharge gas may trigger ultraviolet (UV) light generation, followed by emission of visible light by the photoluminescent layers 117. The photoluminescent layer 117 may be formed on any portion of an inner surface of the discharge cells 120, e.g., an upper surface of the rear dielectric layer 113 and/or on side surfaces of the barrier ribs 114. The photoluminescent layers 117 may include a phosphor layer emitting red light, e.g., (Y,Gd)BO₃;Eu⁺³, a phosphor layer emitting green light, e.g., Zn₂SiO₄:Mn²⁺, and/or a phosphor layer emitting blue light, e.g., BaMgAl₁₀O₁₇:Eu²⁺.

The short-circuit prevention units 604 of the PDP 100 may be formed between adjacent electrode terminals 204, i.e., terminals of either the sustain electrodes 103 or the address electrodes 112, in order to prevent short-circuit therebetween. For example, as illustrated in FIG. 3, a plurality of short-circuit prevention units 604 may be formed on the rear substrate 102 in the non-display area 202 between adjacent electrode terminals 204, i.e., terminals of the address electrodes 112, along a boundary line between the display and non-display areas 201 and 202. The short-circuit prevention units 604 may extend integrally from the rear dielectric layer 113, and may be formed of a substantially same material as the rear dielectric layer 113.

In detail, each short-circuit prevention unit 604 may be a rectangular longitudinal protrusion between two adjacent electrode terminals 204, and may be positioned on a same plane therewith. The short-circuit prevention unit 604 may extend from either the rear dielectric layer 113 or the front dielectric layer 110 in a direction of the address electrodes 112 or the sustain electrodes 103, respectively. A length of the short circuit prevention units 604, i.e., a distance as measure from an edge of the dielectric layer, may substantially equal a length of the electrode terminals 204. Therefore, the short-circuit prevention units 604 may form a repetitive pattern interposed between the electrode terminals 204, so that the electrode terminals 204 may be blocked from each other. In this respect, it should be noted the short-circuit prevention units 604 are illustrated and described with respect to the address electrodes 112 for ease of illustration only, and the short-circuit prevention units 604 may be formed on the front substrate 101 between terminals of the sustain electrodes 103.

Accordingly, even if silver is used to form the electrode terminals 204, the short-circuit prevention units 604 disposed therebetween may physically block a potential migration path between the electrode terminals 204. Such blocking may substantially minimize or prevent electron migration between adjacent electrode terminals 204 despite ionization thereof due to moisture in the air, thereby minimizing or preventing a short-circuit therebetween.

The signal transmission unit 205 of the PDP 100 may be formed in any suitable shape, and may be connected to the electrode terminals 204, as illustrated in FIG. 2, to drive the PDP 100. More specifically, the signal transmission unit 205 may be connected between the electrode terminals 204 and a driving circuit unit 209 to transmit electric signals therebetween. The signal transmission unit 205 may include a plurality of driving integrated circuits (ICs) 206, a plurality of leads 207 patterned to be connected to the driving ICs 206, and a flexible film 208 covering the leads 207. The leads 207 may form an electrical connection between the signal transmission unit 205 and the electrode terminals 204 via, e.g., a first terminal 207a, i.e., a terminal formed at an edge of the leads 207. A connector 210 may form an electrical connection between the signal transmission unit 205 and the driving circuit unit 209 via, e.g., a second terminal 207b.

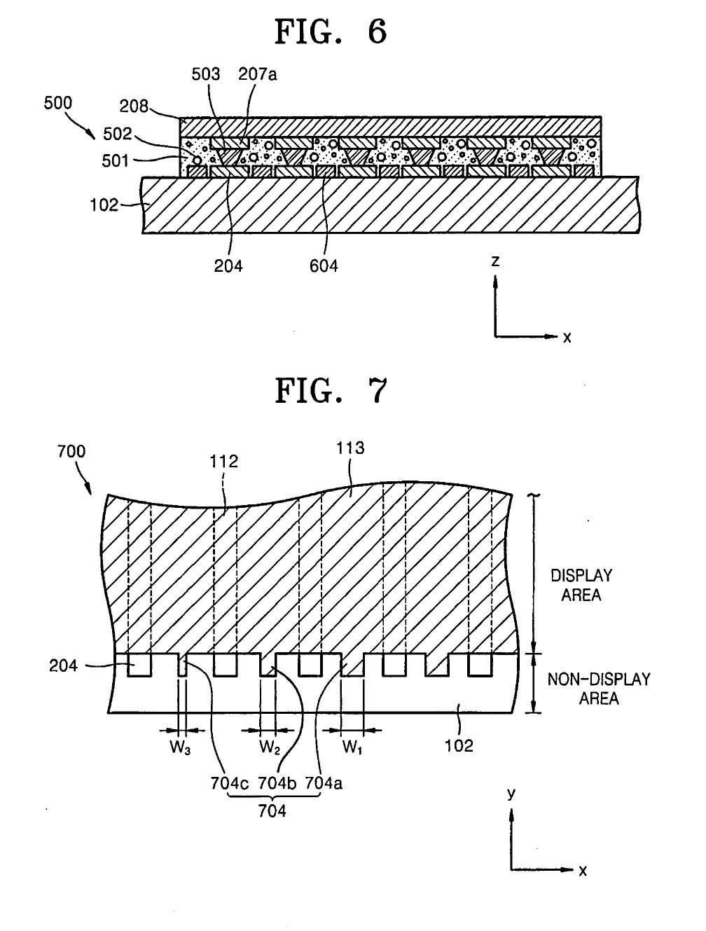

More specifically, as illustrated in FIG. 4, the first terminal 207a of the signal transmission unit 205 may be positioned on an upper surface of the electrode terminal 204, so the first terminal 207a and the electrode terminal 204 may be parallel to each other. A connection member 301 may be disposed between the electrode terminal 204 and the first terminal 207a to facilitate transmission of electric signals therebetween. The connection member 301 may be an anisotropic conductive film (ACF) 400 or a non-conductive film 500, as will be discussed in more detail below with respect to FIGS. 5-6. A sealing material 302, e.g., silicon, may be applied to seal the connection member 301, the electrode terminals 204, and first terminal 207a. In particular, the sealing material 302 may be applied on the first terminal 207a and rear substrate 102, as illustrated in FIG. 4, and hardened in order to seal the connection member 301.

The ACF 400, as illustrated in FIG. 5, may include an adhesive layer 401, a conductive particle layer 402, and an insulating member 403. The adhesive layer 401 may be any suitable conductive resin. The conductive particle layer 402 may include a plurality of, e.g., circular, conductive particles dispersed within the adhesive layer 401, and may be positioned between the electrode terminals 204 and the leads 207 and in communication therewith. The insulating member 403 may be a discontinuous insulating layer disposed in portions of the adhesive layer 401 that do not include the conductive particle layer 402. More specifically, the insulating member 403 may be coated on the conductive particle layer 402, followed by pressing the leads 207, the conductive particle layer 402, and the electrode terminal 204 together, so that the insulating member 403 may be forced away from the conductive particle layer 402.

In other words, the insulating member 403 may be sufficiently thin to be broken down and to be displaced along the horizontal direction, i.e., along the y-axis, due to vertical compression between the first terminal 207a, the conductive particle layer 402, and the electrode terminal 204, thereby forming gaps in the insulating member 403 around the conductive particle layer 402. Accordingly, electrical connection between the first terminal 207a and the electrode terminal 204 may be established via the conductive particle layer 402, while the insulating member 403 may tightly surround the conductive particle layer 402 without interrupting conduction thereof. As such, portions of the insulating member 403 disposed within the adhesive layer may provide sufficient insulation between the electrode terminals 204.

The non-conductive film 500 may be formed between the electrode terminals 204 and the leads 207 to electrically connect therebetween, as illustrated in FIG. 6. The non-conductive film 500 may include an adhesive layer 501 and non-conductive particles 502. The adhesive layer 501 may be any suitable polymer resin, and may be deposited between the electrode terminals 204 and the leads 207. The non-conductive particles 502 may be, e.g., circular, particles dispersed within the adhesive layer 501. Protrusions 503 may be formed of a conductive material, and may be positioned between the electrode terminals 204 and the leads 207 through the adhesive layer 501.

More specifically, the protrusion 503 may have a non-uniform cross-sectional area. For example, the protrusion 503 may have an inverted trapezoidal cross-sectional area, i.e., narrowing cross-sectional area from the first terminal 207a toward the electrode terminal 204. Accordingly, when pressing together the first terminal 207a and the electrode terminal 204 with the protrusion 503 therebetween, a narrower portion of the protrusion 503 may penetrate through the adhesive layer 501 to be in communication with the electrode terminal 204, as further illustrated in FIG. 6. Penetration of the protrusions 503 through the adhesive layer 501 may provide electrical connection therethrough between the electrode terminals 204 and the leads 207, while the adhesive layer 501 may tightly surround the electrode terminals 204, thereby providing sufficient insulation therebetween. Dispersion of the non-conductive particles 502 in the adhesive layer 501 may maintain the adhesive layer 501 as a non-conductive medium.

According to another embodiment illustrated in FIG. 7, a PDP 700 may be substantially similar to the PFP 100, with the exception of having a plurality of short-circuit prevention units 704 with a non-uniform width along the x-axis. More specifically, the short-circuit prevention units 704 may be wider in a center portion of the group unit of the electrode terminals 204 as compared to short-circuit prevention units 704 at edges thereof, so that a width of each short-circuit prevention unit 704 may gradually decrease with respect to a distance thereof from the center of the group unit.

For example, as further illustrated in FIG. 7, the short-circuit prevention units 704 may include first, second, and third short-circuit prevention units 704a, 704b, and 704c. The first, second, and third short-circuit prevention units 704a, 704b, and 704c may have first, second, and third widths W1, W2, and W3, respectively. The first width W1 of the first short-circuit prevention units 704a may be wider than the second and third short-circuit prevention units 704b and 704c, and may be positioned substantially in a center of a group unit of electrode terminals 204, i.e., between electrode terminals 204 that may be driven more often in the group unit. Similarly, the third short-circuit prevention units 704c may be narrower than the first and second short-circuit prevention units 704a and 704b, and may be positioned at edges of a group unit of electrode terminals 204, i.e., between electrode terminals 204 that may be driven less often in the group unit. Therefore, even if migration of Ag particles occurs between the electrode terminals 204, distances between the electrode terminals 204 may be increased, thereby minimizing potential short-circuits between adjacent electrode terminals 204.

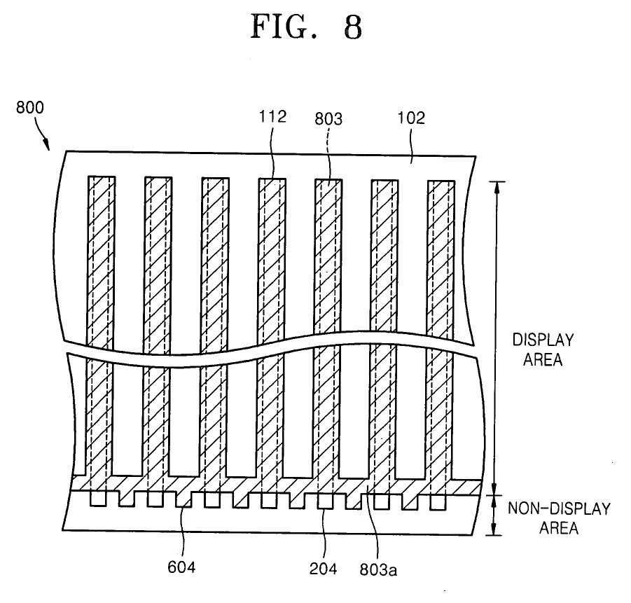

According to yet another embodiment illustrated in FIG. 8, a PDP 800 may be substantially similar to the PDP 100, with the exception of having a rear dielectric layer 803 covering selectively only predetermined portions of the display area 201. In detail, the rear dielectric layer 803 may be a non-continuous layer with gaps therein. In further detail, the rear dielectric layer 803 may include a plurality of vertical portions substantially overlapping with the address electrodes 112, so that gaps may be formed between the address electrodes 112 to expose the rear substrate 102. The rear dielectric layer 803 may further include a horizontal portion 803a in the display area 201 along the boundary line between the display and non-display areas 201 and 202, i.e., a continuous horizontal portion connecting all the vertical portions. Since the address electrodes 112 may be selectively covered by the dielectric layer 803, invalid power consumption during the discharge may be reduced. In addition, the short-circuit prevention units 604 may substantially minimize or prevent electron migration between the electrode terminals 204.

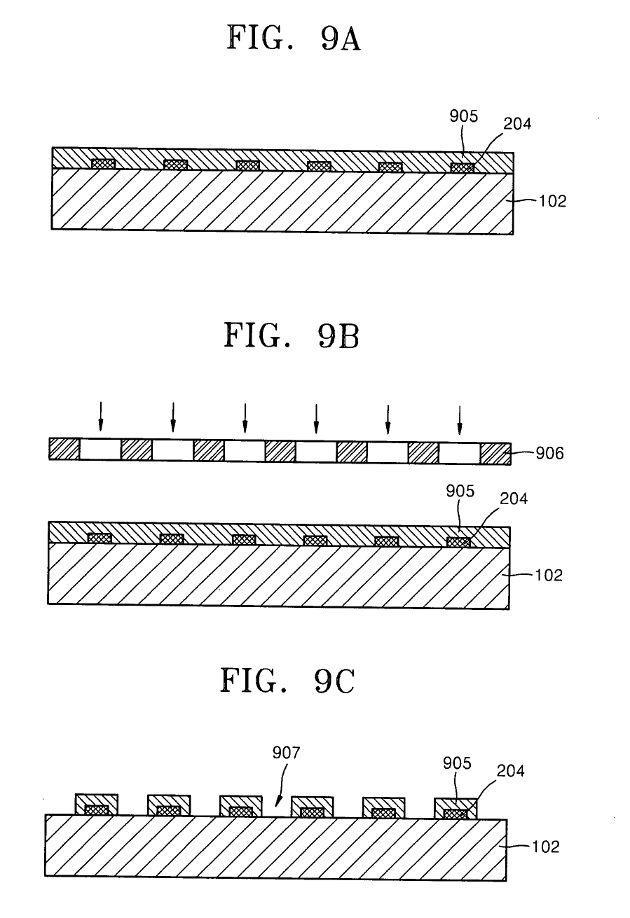

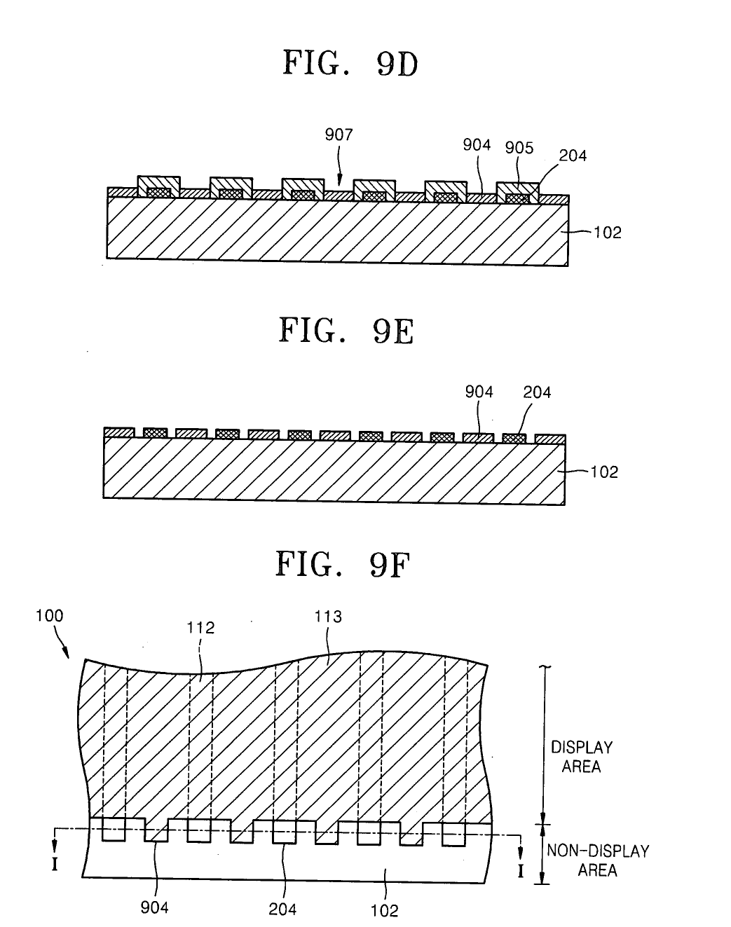

Fabrication of short-circuit prevention units in a PDP according to embodiments of the present invention, e.g., the PDP 100, will be described in more detail below with reference to FIGS. 9A-9F, which illustrate cross-sections through a non-display area. Patterns of the address electrodes (not shown) may be formed on an upper surface of the rear substrate 102 at predetermined intervals, so the address electrodes may extend from the display area (not shown) toward the non-display area. Portions of the address electrodes 112 formed on the non-display area of the rear substrate 102 may be patterned to form the electrode terminals 204, as illustrated in FIG. 9A. A dry film resist (DFR) 905 may be disposed on the rear substrate 102 to cover the electrode terminals 204 in the non-display area.

Next, as illustrated in FIG. 9B, a mask 906 may be aligned above the rear substrate 102 to expose portions of the DFR 905 corresponding to the electrode terminals 204. The DFR 905 may be exposed and developed through the mask 906 to remove portions of the DFR 905 between the electrode terminals 204 and to form openings 907, as illustrated in FIG. 9C. In other words, the DFR 905 may be patterned to correspond to patterns of the dielectric layer 113 and the short-circuit prevention units 604 to be formed on the rear substrate 102. A layer of DFR 905 may remain on the electrode terminals 204.

A dielectric material 904 may be disposed on the rear substrate 102 to cover the address electrodes in the display area (not shown) and to extend between the electrode terminals 204 in the openings 907 in the non-display area, as illustrated in FIG. 9D. The layer of DFR 905 on the electrode terminals 204 may prevent deposition of the dielectric layer thereon. Portions of the dielectric material 904 in the openings 907 may be patterned to form the short-circuit prevention units 604, and the remaining DFR 905 may be removed to expose the electrode terminals 204, as illustrated in FIG. 9E. Simultaneous formation of the dielectric layer 113 and the short-circuit prevention units 604 may decrease manufacturing costs and time. As illustrated in FIG. 9F, the short-circuit prevention units 604 may extend as protrusions from an edge of the dielectric layer 113 and positioned between adjacent electrode terminals 204.

Alternatively, the dielectric layer 113 in the display area may be patterned as a non-continuous layer in order to cover only the address electrodes 112, i.e., portions of the dielectric material between the address electrodes 112 may be removed to expose the upper surface of the rear substrate 102. A portion of the dielectric material along a boundary line between the display and non-display areas may remain on the rear substrate in order to facilitate connection between the dielectric layer and the short-circuit prevention units.

A PDP according to embodiment of the present invention, e.g., the PDP 100, may operate as follows. A predetermined voltage from an external power source may be applied between the address electrodes 112 and the Y electrodes 105 to select discharge cell 120 to be operated, i.e., discharge cells 120 to emit light. Application of voltage to the address electrodes 112 and the Y electrodes 105 may cause accumulation of wall charges on inner side surfaces of the selected discharge cells 120.

Next, positive voltage may be applied to the X electrodes 104 of the selected discharge cells 120, and high voltage, i.e., higher voltage as compared to the voltage of the X electrodes 104, may be applied to the Y electrodes 105 of the selected discharge cells 120. Accordingly, the voltage difference between the X and Y electrodes 104 and 105 may trigger movement of the accumulated wall charges. Movement of the wall charges may trigger collisions between the wall charges and the discharge gas particles in the discharge cell 120, thereby activating discharge and plasma generation. The discharge may start from a discharge gap between the X and Y electrodes 104 and 105, and may spread to outer portions of the X and Y electrodes 104 and 105.

After the discharge occurs, the voltage difference between the X and Y electrodes 104 and 105 may be lower than a discharge voltage, thereby providing discharge suspension and accumulation of spatial charges and wall charges in the discharge cells 120. At this time, polarities of voltages applied to the X and Y electrodes 104 and 105 may be changed, thereby triggering a new discharge via collisions between the wall charges and the discharge gas. A continuous change of voltage polarities, as described above, may cause a repeated discharge process. UV light generated during the discharge may excite the photoluminescent layers 117, thereby emitting visible light. The visible light may be emitted from the discharge cell 120 toward the substrate to form images.

A PDP according to embodiments of the present invention may be advantageous in providing short-circuit prevention units between the electrode terminals, thereby substantially minimizing or preventing a potential short-circuit therebetween due to electrode ionization. In addition, selective formation of the dielectric layer on upper portions of the discharge electrodes may significantly reduce invalid power consumption.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as defined by the following claims.

What is claimed is:

1. A plasma display panel (PDP), comprising:
first and second substrates positioned in parallel to each other to define display and non-display areas;
a plurality of barrier ribs between the first and second substrates;
a plurality of discharge electrodes between the first and second substrates, the discharge electrodes having electrode terminals in the non-display area;
a dielectric layer on the discharge electrodes in the display area; and
a plurality of short-circuit prevention units between the electrode terminals.

2. The PDP as claimed in claim 1, wherein each short-circuit prevention unit is between two adjacent electrode terminals.

3. The PDP as claimed in claim 1, wherein the short-circuit prevention units are connected to the dielectric layer.

4. The PDP as claimed in claim 3, wherein the short-circuit prevention units are integral with the dielectric layer.

5. The PDP as claimed in claim 1, wherein a length of the short-circuit prevention units substantially equals a length of the electrode terminals.

6. The PDP as claimed in claim 1, wherein the short-circuit prevention units include a dielectric material.

7. The PDP as claimed in claim 1, wherein the short-circuit prevention units have a structure of group units.

8. The PDP as claimed in claim 7, wherein the short-circuit prevention units have non-uniform widths.

9. The PDP as claimed in claim 8, wherein short-circuit prevention units in a center of each group unit are wider than short-circuit prevention units at an edge of each group unit.

10. The PDP as claimed in claim 1, wherein the dielectric layer is non-continuous and is connected to the short-circuit prevention units.

11. The PDP as claimed in claim 1, further comprising at least one signal transmission unit electrically connected to the electrode terminals.

12. The PDP as claimed in claim 10, wherein the signal transmission unit includes a driving integrated circuit (IC) and at least one lead connected to the driving IC, the lead being connected to a respective electrode terminal.

13. The PDP as claimed in claim 12, further comprising a sealing member around a connection region of the electrode terminal and its respective lead.

14. The PDP as claimed in claim 12, further comprising a connection member between each lead and its respective electrode terminal.

15. The PDP as claimed in claim 14, wherein the connection member is an anisotropic conductive film.

16. The PDP as claimed in claim 14, wherein the connection member is a non-conductive film.

17. A method of fabricating a plasma display panel (PDP), comprising:
patterning discharge electrodes on a substrate;
depositing a dry film resist on the substrate to cover terminals of the discharge electrodes;
exposing and developing the dry film resist to form negative patterns;
printing a dielectric material on the substrate;
patterning the dielectric material to form a plurality of short-circuit prevention units in the negative patterns and a dielectric layer on the substrate, such that the short-circuit prevention units and the dielectric layer are in communication with each other; and
removing the dry film resist to expose the electrode terminals.

18. The method as claimed in claim 17, wherein patterning the dielectric material includes forming the dielectric layer and the plurality of short-circuit prevention units simultaneously.

19. The method as claimed in claim 17, wherein patterning the dielectric material to form the dielectric layer includes forming a non-continuous dielectric layer substantially overlapping with the discharge electrodes.

20. The method as claimed in claim 17, wherein patterning the dielectric material to form the short-circuit prevention units includes forming protrusion between adjacent discharge electrodes.
